(19) United States
(12) Patent Application Publication
(10) Pub. No.: US 2003/0153376 A1
(43) Pub. Date: Aug. 14, 2003

(54) Method of playing a card game wih card choise system

(76) Inventor: Gerald Duhamel, Quebec (CA)

Correspondence Address: OGILVY RENAULT, 1981 MCGILL COLLEGE AVENUE, SUITE 1600, MONTREAL, QC, H3A2Y3, CA

(21) Appl. No.: 10/257,978

(22) PCT Filed: May 3, 2001
(86) PCT No.: PCT/CA01/00606

(51) Int. Cl. A63F 13/00

(52) U.S. Cl. 463/13

(57) ABSTRACT

The card choice system offers to gamers two parallel hands of cards to choose from to compose a Poker hand. Gamers choose cards from the two sets displayed one above and one below, and move cards into the Poker hand while respecting the same position for the card. When the gamer has chosen all the cards they want to be part of the Poker hand, the cards still available from the original sets are discarded and removed from the display. Next, new cards are dealt from the same card deck that dealt the original sets of cards to complete the Poker hand. The hand yielded is the final outcome of the Poker game and is further evaluated with a prize being awarded to the gamer if the final poker hand corresponds to a winning criterion.

### FIELD OF INVENTION

The present invention is a method and apparatus for playing a card game with a card choice system in a gambling environment. Furthermore, the invention can be applied either in electronic gaming devices or on casino tables.

### BACKGROUND OF THE INVENTION

Card games are ones of the most popular gambling games since decades, especially Poker games and Blackjack games. These games were played a long time ago and will still be played far into the future based on the relatively simple rules of these games and the strategy of play required by these games.

Since the development of electronic gaming devices, electronic displays, and similar technologies, Poker games and Blackjack games have been installed on electronic gaming devices with the consequence being, that everybody can play these games whenever they want and in many locations where before it was impossible before. Because of the growing popularity of these games played on electronic gaming device, game designers developed and continue to develop new series of rules offering interesting prospects to gamers.

In the development of new Poker games, different strategies were used: gamers placing different bets during the play of the game, the dealing of different number of cards to gamers during the play of the game, the dealing of the cards differing from the standard rules, the change or addition of cards according to different winning combinations of cards, the process of the choice in the cards differing from the standard rules, and even the offering of new kinds of displays to dispose the cards. Some of these different strategies changing the optimum strategy of play. The method of the present invention relates to both the process of the choice of the cards and the display of the cards during the game.

The MODIFIED POKER GAME of Singer, U.S. Pat. No. 5,897,436, presents a method of playing a Poker hand offering to players sequentially for each additional card of the Poker hand a choice between two cards. In more detail, a player playing the MODIFIED POKER GAME is initially dealt two cards disposed one above the other. Once the player chose which of the two cards to discard, the card is removed from the display. Afterwards, two new cards are displayed beside the first card previously held. The player continues the same steps until a complete Poker hand is build. Then, the play continues as in any regular Poker game. The MODIFIED POKER GAME offers an interesting way to choose cards. However the method does not allow players a fast built of a Poker hand. Slowing the game has consequence of disturbing the rhythm of the game. Even if the attraction of the Poker game is based on the strategy of the play, the rhythm of the game also has an importance. If the game does not succeed to keep both attractions, the game does not please players. Consequently the MODIFIED POKER GAME of Singer fails to attract players.

The DOUBLE POKER of Dabrowski, U.S. Pat. No. 5,356,140, presents a method allowing players to have a choice between two separate Poker hands composed of cards coming from different card decks. In this method, once players have wager a bet, the electronic gaming device simultaneously displays two independent Poker hands; the first one being dealt from a first card deck, and the second one from a second deck. The player chooses which of the two initial Poker hands please them more, and discard the other Poker hand. Once the Poker hand discarded, the play continues as in any regular Poker game. The DOUBLE POKER of Dabrowski offers a fast and easy way to choose cards. However, it does not offer to players new challenges; the game is still the same, including the best strategy of play. Further, the fact that some cards have been dealt in the discarded Poker hand does not influence the play. The ultimo result of the method is only to lower the pay table of the game in regard to the easiness associated to the present method.

However, none of the methods above offer interesting possibilities to obtain a good Poker hand with a fast choice possibility. Furthermore, none of the methods above allows to offer interesting prospects to both the gamers and the casino managers. Moreover, the methods do not offer the flexibility to be adaptable to numerous kinds of games. The method of the present invention is applicable on almost every game demanding the garners decisions during the process of the game. Therefore, the method has the flexibility to allow gamers and casino managers to use the method in many situations to maintain the interest of the gamers in numerous games.

### SUMMARY OF THE INVENTION

Accordingly, it is the objective of the invention to provide a method of playing a card game offering a fast build in a combination of cards.

Another objective is to offer a method that can be applied in both environments: on electronic gaming apparatus and on live casino tables.

Another objective is to offer a method that is simple, therefore not demanding too much time for a new gamer to understand.

Another objective is to offer a method that can easily be reproduced by gamers as their home, therefore allowing them to practice, and thus find the best strategy regarding this method.

Another objective is to offer a method that does not demand too mush space to display, therefore allowing the method to be applied on a regular screen of an electronic gaming device without changing mush of the general display of the game.

Therefore, the method of the present invention consists of offering in the first embodiment two Poker hands displayed in a parallel manner with enough space between these two hands to place a third Poker hand. Furthermore, the process of playing consists of offering to gamers to choose the cards to compose a final Poker hand from the cards of the two parallel Poker hands. More precisely, it consists of moving cards from the above or the below hand into the middle hand yielding the final Poker hand. Next, the gamer is dealt cards to complete the Poker hand that is afterwards evaluated. According to the evaluation, the gamer is paid a prize for this Poker hand.

A second embodiment consists of using the same method with a Poker game. However, the gamer must choose all the cards composing the final Poker hand from the two displayed Poker hands.

A third embodiment consists of using approximately the same method always with a Poker game, but only with partial selection of the cards composing the Poker hand. This method can be applied for the first three cards of the Poker hand. Afterwards, the gamer receives two cards to complete the hands. With these two cards, the gamer has the possibility to hold the cards they want and discarded cards are replaced to yield the final Poker hand.

Another embodiment consists of using the same method with a Blackjack game.

However, even if the gaming symbols used in the above embodiments are cards, other gaming symbols can be used in regard to the game played. Furthermore, the Poker hand displayed in the embodiments are called hand in regard to the Poker. However, with another game, the gaming symbols displayed should be displayed as sequences of gaming symbols. The display should allow player to see the relation the gaming symbols have with each other of in regard to the disposition of the sequences of gaming symbols. Furthermore, the prize awarded or the payout value should be displayed clearly to attract players, and consequently help the popularity of the game.

### BRIEF DESCRIPTION OF THE DRAWINGS

These and other features, aspects, and advantages of the present invention will be better understood with regards to the following description and accompanying drawings, wherein:

FIG. 1 is a schematic representation of the play screen according to the first embodiment;

FIG. 2 is a schematic representation of FIG. 1 further in the play; and

FIG. 3 is a schematic representation of FIG. 2 further in the play;

FIG. 4 is a flow chart of the embodiment;

FIG. 5 is a block diagram illustrating the embodiment;

FIG. 6 is a schematic representation of the screenplay according to another embodiment;

FIG. 7 is the flow chart illustrating the embodiment in FIG. 6;

FIG. 8 is a schematic representation of the screenplay according to another embodiment;

FIG. 9 is a schematic representation of the embodiment of FIG. 8 further in progress;

FIG. 10 is a schematic representation of the embodiment of FIG. 9 further in progress;

FIG. 11 is the flow chart illustrating the embodiment found in FIGS. 8, 9 and 10;

FIG. 12 is a schematic representation of the screenplay according to a last embodiment;

FIG. 13 is a schematic representation of the embodiment in FIG. 12 further in progress; and

FIG. 14 is the flow chart illustrating the embodiment found in FIGS. 12 and 13.

### DETAILED DESCRIPTION OF THE DIFFERENT EMBODIMENTS

A first embodiment of the method of this invention consists of playing a Poker game on an electronic gaming device. Furthermore, the play of the Poker game operation processes with the method of the present invention. More precisely, the gamer sees displayed in front of them two sets of cards, these sets having the same number of cards as a Poker hand. Furthermore, these sets are disposed in a parallel manner with enough space for a third Poker hand placed between the two other sets.

During the process of the game, the gamer chooses the cards they want to keep from the cards appearing on the screen The cards must be chosen to be used in the same position as they were in the initial sets of cards. Therefore, the cards are moved vertically either from the line above or below to the line corresponding to the third Poker hand. After all the cards have been chosen, the two initial sets of cards disappear and any new cards are dealt from the deck to fill empty spaces left in the Poker hand. After all these steps, the Poker hand is considered as complete. The hand is evaluated and a prize is awarded to the gamer according to the evaluation of the hand.

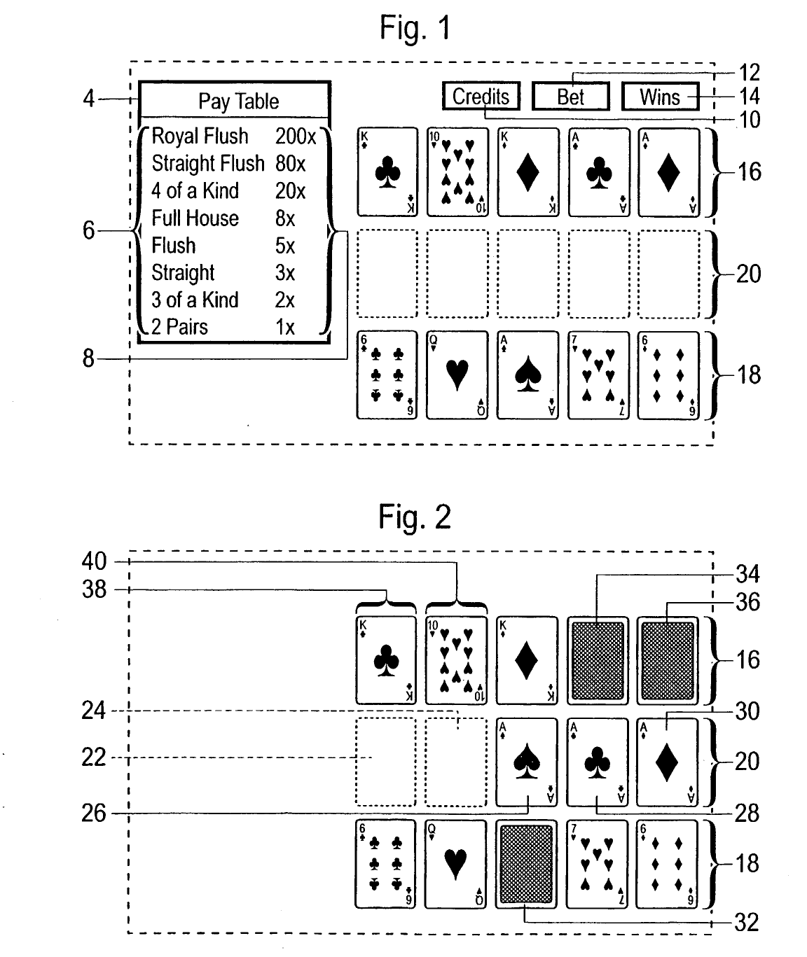

FIG. 1 is a schematic display of the screen of an electronic gaming device during the first step of the game. The screen displays a pay table 4 for the evaluation of the Poker hands. This pay table 4 is comprised of a list of winning combinations 6 along with the prizes 8 associated with each of these winning combinations 6. Furthermore, the screen is comprised of the number of credits 10 the gamer owns in the electronic gaming device, the value of the bet 12 placed by the gamer previously to the dealing of the cards, and an area to display the value of the prize won 14 by the gamer. The game display itself is initially shown after the dealing of the cards two sets of cards 16 and 18 and enough space 20 between the two sets 16 and 18 to receive a third set of cards. The two sets of cards 16 and 18 are placed one above and one below the center space. Therefore, when a card is chosen by the gamer to be part of the Poker hand, the card either moves up to the corresponding available space in the Poker hand 20 if the card comes from the lower set 18, or moves down if the card comes the higher set 16.

FIG. 2 illustrates the result of the partial display corresponding to the play of the cards after the process of a gamer choosing the cards being part of Poker hand. As can be seen, the two first areas 22 and 24 corresponding to the two first cards of the Poker hand are empty; therefore the areas are still available to receive cards. However, the three other areas 26, 28 and 30 are filled with cards. The third area 26 is filled with a card originally displayed on the area 32 coming from the lower set 18; therefore the third area 32 of the lower set 18 is empty. The fourth 28 and fifth 30 areas are filled with cards originally displayed on areas 34 and 36 coming from the higher set 16, therefore the fourth 34 and the fifth 36 areas of the higher set 16 are now empty. Because the available cards of the two first positions 38 and 40 of both sets 16 and 18 are not wanted to complete the Poker hand 20, the two first areas of the Poker hand 22 and 24 are still empty.

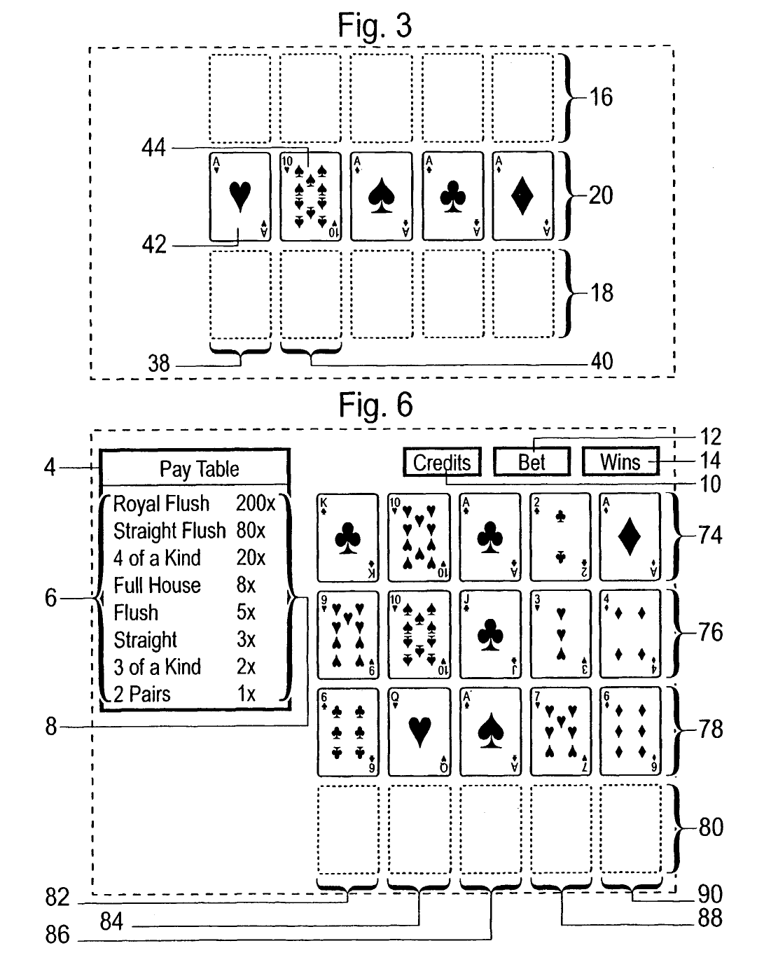

FIG. 3 presents a partial display further in the progress of play once new cards are dealt. The display shows the Poker hand 20; the two sets 16 and 18 of cards were removed from the display simultaneously at the dealing of new cards 42 and 44. Therefore, seeing the final Poker hand 20 becomes easier for the gamer. Furthermore, the two first areas 38 and 40 of the Poker hand are filled with the new cards 42 and 44. These cards 42 and 44 were dealt from the same deck of cards that dealt the two initial sets 16 and 18 of game cards. All the cards using through out the process of the play come from the same deck of cards as like in a standard Poker game. At this stage of the game, the Poker hand 20 is final, therefore evaluated and awarded 14 accordingly regards to the pay table 4. Furthermore, to ease understanding the game, the category of the winning combination 6 and the prize 8 corresponding to the final Poker hand 20 are highlighted and the prize is also displayed in the area for the win value 14. The value of the win 14 is added to the counter monitoring the credits owned 10 by the gamer and displayed in the corresponding area.

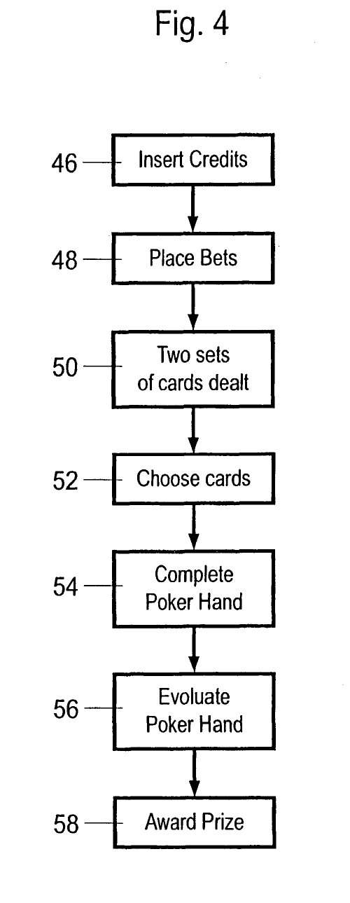

FIG. 4 illustrates the steps of playing the Poker game. First, the gamer inserts credits 46 in the electronic gaming device. Next, the gamer places bets 48 using the credits they place in the device. Afterwards, the play starts and the gamer is dealt two sets of cards 50. Then, choose the cards they want to keep 52 by touching them. The cards touched move from their original place to the area of the Poker game corresponding to their original position. When all the cards are chosen, the gamer presses the DEAL button, therefore giving the signal to continue play. The two sets of cards are now erased from the screen and cards are dealt to fill any available spaces left 54 in the Poker hand. At this time, the Poker hand is evaluated 56 and the gamer is awarded 58 a prize according to this evaluation. After completion of these steps, the gamer is ready to start a new play.

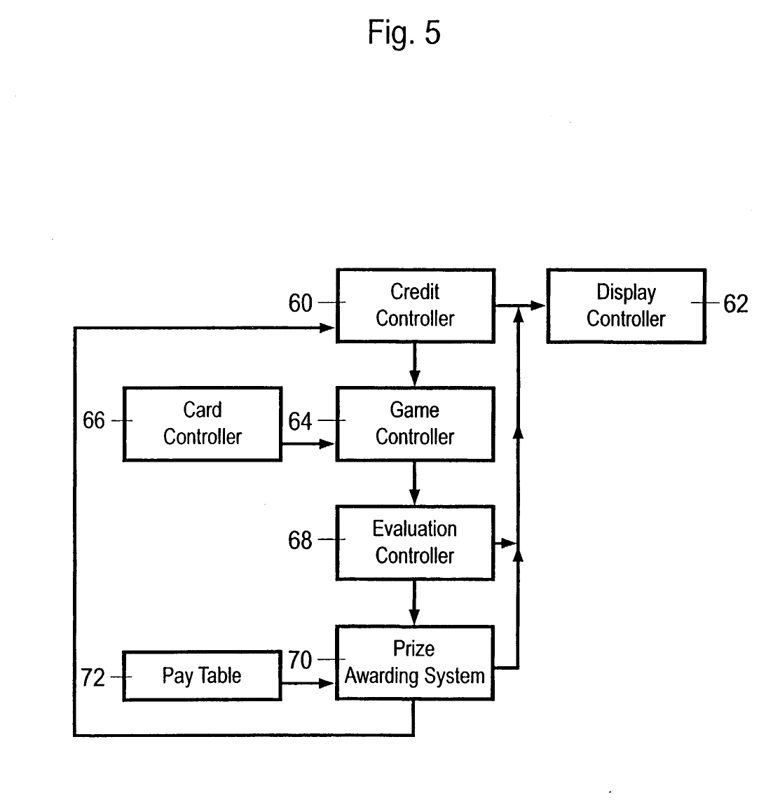

FIG. 5 illustrates how the Poker game works using a block diagram. First, there is a credit controller 60 receiving and managing all the credit values inserted by the gamer. It is also the credit controller 60 that manages the bets placed on the play. All this information is displayed by the display controller 62. Then, the game controller 64 allows the play to begin. The game controller 64 sends signals to the display controller 62 in regards to the cards to display. The cards are determined and fed by the card controller 66 to the game controller 64 from a card deck. The game controller 64 allows the play to be played to its final outcome. Afterwards, the evaluation controller 68 evaluates the Poker hand. And the prize awarding system 70 awards the prize to the gamer according to the evaluation made by the evaluation controller 68, the bet placed by the gamer, and the pay table 72. In this process, the pay table 72 sends information regarding the counter monitoring the value of the prize. The prize is then awarded to the gamer, therefore added to the credits the gamer owns managed by the credit controller 60. To keep the gamer with accurate information at all times, the credit controller 60, the game controller 64, the evaluation controller 68 and the prize awarding system 70 send signals to the display controller 62, allowing the display controller 62 to display the corresponding information on the screen of the electronic gaming device.

Another embodiment consists of using the basic rules of Draw Poker. The method of play of this embodiment consists of displaying three initial sets of cards, and allowing the gamer to choose all the cards composing their final hand from the initial sets of cards. When all the cards are chosen from the initial sets, no new cards are dealt to the gamer. Therefore, the gamer must compose his final Poker hand form only the cards found in the initial sets of cards. Once again, the method is applied on an electronic gaming apparatus.

FIG. 6 shows schematically the screen of the Poker game. It shows the same elements from the screens above: a pay table 4, the credit values 10 in the electronic gaming device, the value of the bet 12, and the value of the win 14. Furthermore, the screen shows three initial sets of cards 74, 76 and 78 displayed below the areas corresponding to the final Poker hand 80. The cards are placed in rows 82, 84, 86, 88 and 90 allow the gamer to choose from any of the cards of a like row to be placed in the Poker game hand and used in that same row. Therefore, gamers do not have fifteen cards available 74, 76 and 78 to compose the best Poker hand 80, but five (5) times three (3) cards to compose the five cards of the Poker hand 80. It is much more difficult to yield a good Poker hand from five times three cards than from fifteen cards. An example: if fifteen (15) cards can comprise all the five cards corresponding to a royal flush, but using the five (5) times three (3) card choice two of these cards are in a same row, and the best Poker hand that can be yielded is not a royal flush.

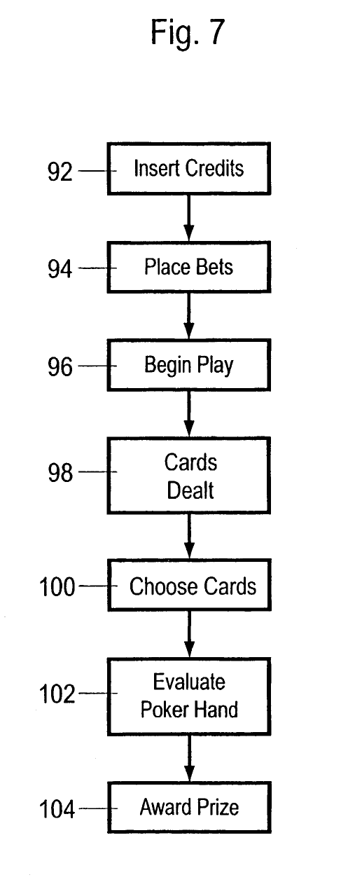

FIG. 7 presents in a schematic the steps of playing a Poker game in this embodiment. First, the gamer inserts credits 92 in the electronic gaming device for further use to place bets 94. The gamer then chooses the amount of the bet 94 used to play the game and presses the DEAL button 96, informing the electronic gaming device that all the steps previous to the game have been completed. At this time, three sets of cards are dealt 98 one above the other. The sets comprise a number of cards corresponding to the Poker hand. Now, the gamer has all the information required to make the best decision regarding the cards to use to compose the Poker hand. Then, they choose one card from each of the position of the Poker hand 100 from one of the set of cards with a corresponding position. In other words, the gamer chooses one cards in one of the three sets being in the first position to occupy the first position of the final Poker hand. When all the cards are chosen, or when the gamer presses the DONE button, the remaining cards from the sets are removed and the cards of the Poker hand are evaluated 102. If the Poker hand correspond to one winning hand category, the gamer is awarded a prize 104 in regard to the category of the final poker hand and the bet placed at the beginning of the play.

However, even if the steps of playing a Poker game with this embodiment are different from the first embodiment, the same block diagram can describe both embodiments. FIG. 5 illustrates this. First, there is a credit controller 60 receiving and managing all the credit values inserted by the gamer. It is also the credit controller 60 that manages the bets placed on the play. All this information is displayed by the display controller 62. Then, the game controller 64 allows the play to begin. The game controller 64 sends signals to the display controller 62 in regards to the cards to display. The cards are determined by the cards controller 66 that determines the cards fed to the game controller 64 from a card deck. The game controller 64 allows the play to be played to its final outcome. Afterwards, the evaluation controller 68 evaluates the Poker hand. And the prize awarding system 70 awards the prize to the gamer according to the evaluation from the evaluation controller 68, the bet placed by the gamer, and the pay table controller 72. In this process, the pay table controller 72 sends information regarding the value of the prize. Then, the prize is awarded to the gamer, therefore added to the credits the gamer owns and managed by the credit controller 60. To keep the gamer with accurate information all the time, the credit controller 60, the game controller 64, the evaluation controller 68 and the prize awarding system 70 send signals to the display controller 62, allowing the display controller 62 to display the corresponding information on the screen of the electronic gaming device.

Another embodiment of the method consists of offering a choice of the cards composing a Poker hand for only part of the hand. More precisely, this embodiment consists of offering a choice between two sets of three cards for only the three first cards of the Poker hand. Afterwards, when the three cards are dealt, two additional cards are dealt to fill the empty spaces of the Poker hand. Then, the play continues as any Poker play with the gamer choosing the cards to hold and the other cards to discard and replaced to finally yield the final Poker hand. Afterwards, the Poker hand is evaluated and a prize is awarded according to the evaluation of the Poker hand, marking the final step of playing a play.

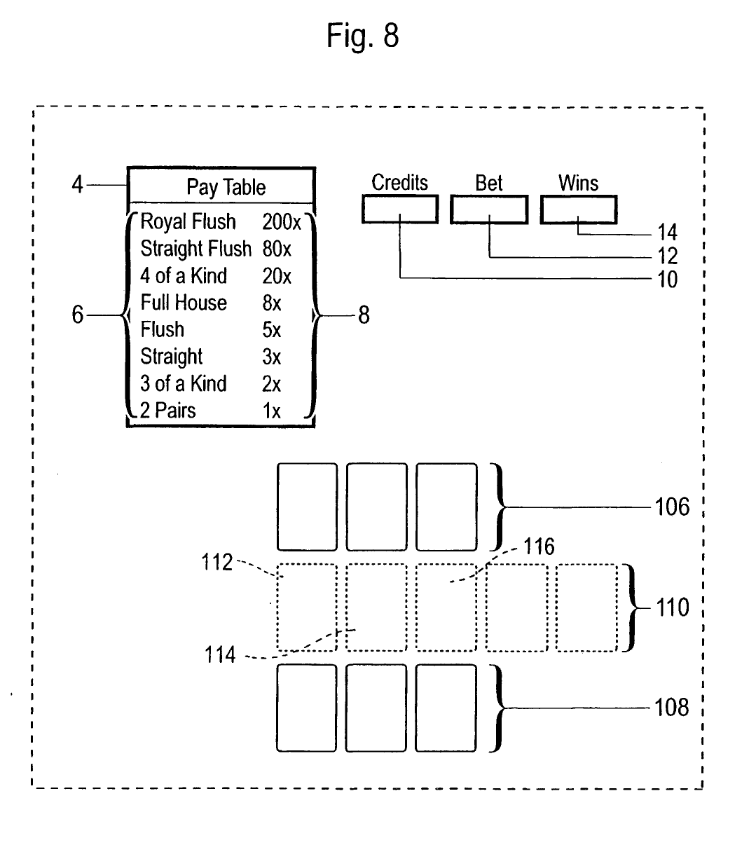

The screen of an electronic gaming device of FIG. 8 shows all the graphic elements composing the play following the method described above. Here present on the screen is a pay table 4 comprising a list of all the categories of winning combinations 6 available in this game and the associated prize 8 in each of these categories, the number of credits by the gamer owns 10 in the electronic gaming device, the actual bet 12 placed and the value of the actual win 14. Furthermore, the screen displays two sets of cards 106 and 108; one set above 106 and one set below 108 the Poker hand 110. These two sets 106 and 108 comprised each of three cards, located above and below the first three areas available 112, 114 and 116 for cards used to compose the Poker hand 110. The screen also comprises areas between the two sets of cards for the cards of the actual Poker hand 110. FIG. 8 shows the point in the game where the gamer receives the two initial sets of cards 106 and 108, but before the choice of any cards to be part of the Poker hand 110 has been made.

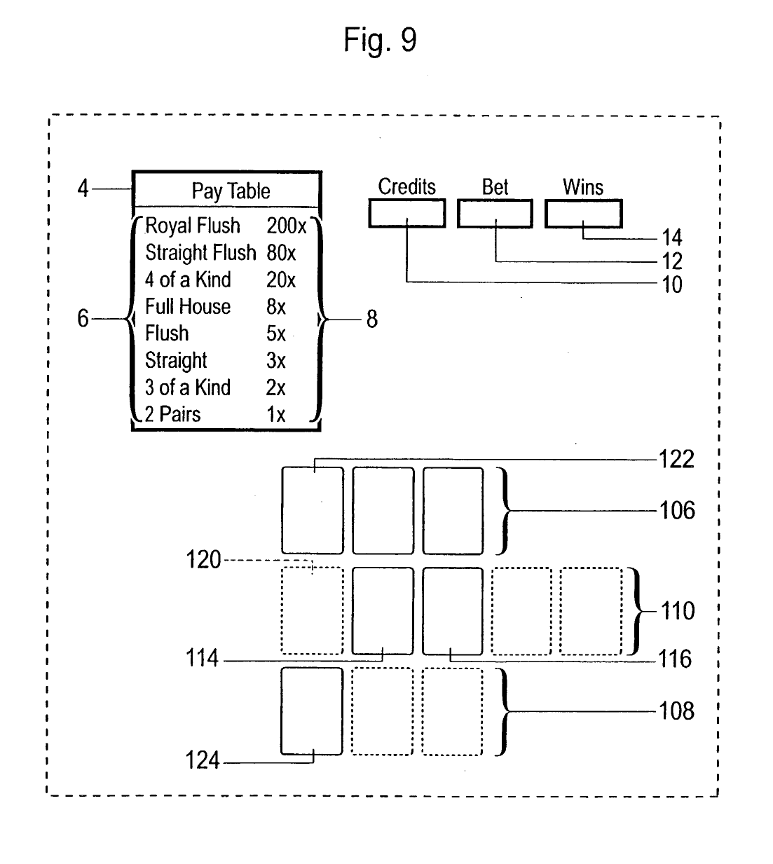

FIG. 9 shows the same play but one step further. This time, the gamer already has chosen the cards to be part of the final Poker hand from the first sets of cards. In this example, the gamer chose the second 114 and the third 116 card from the set below 108. For the first area 120 of the Poker hand 110, the gamer judged that neither of the two cards 122 and 124 available from the two sets 106 and 108 were advantageous. Therefore, the gamer chose not to choose either of the two cards and to be dealt a card directly by the following step of the play.

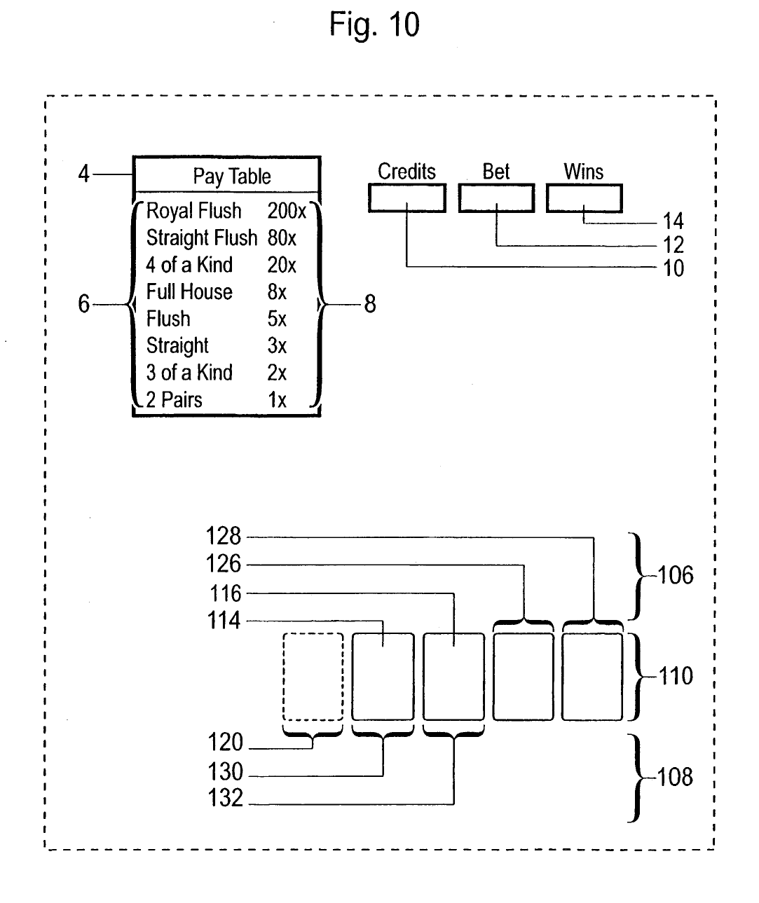

FIG. 10 shows the screen one step further. As can be seen, the areas of the fourth 126 and fifth position 128 are filled with new cards. However, the first area 120 is still empty. Gamers can replace the cards situated in the three first areas 120, 130 and 132 only before the final step of the play. prior to this, these areas were untouchable. Subsequently, the gamer sees all the cards making the Poker hand 110 and can take the best decision over the cards to hold and or discard. It is important to note that the two sets 106 and 108 of cards disappear concurrently at the deal of the new cards used to fill any empty areas. The reason is to avoid any distraction to the gamer and or avoid a visual overload of the electronic gaming device screen stressing the gamer.

Afterwards, the cards not held are discarded and replaced by new cards coming from the same cards deck used for all the cards dealt before: the two sets of cards and the additional cards filling the empty areas. Simultaneously, the available area in the Poker hand is also filled. Therefore, the final Poker hand is yielded, ready to be evaluated to award a prize to the gamer according to evaluation. All the necessary steps to complete the play of the Poker game have been completed, and a new play can begin.

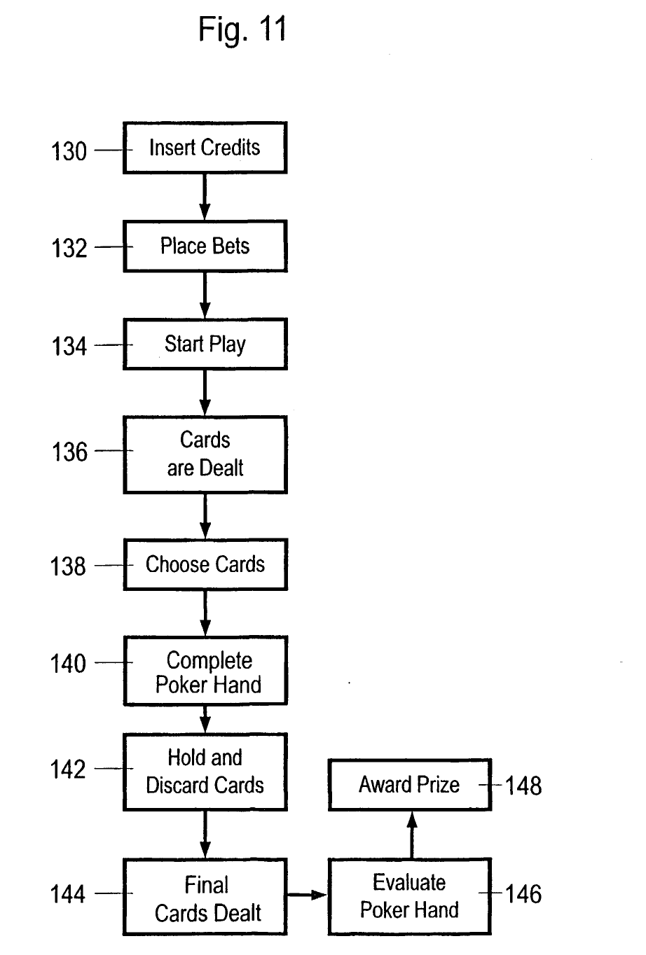

The flow chart of FIG. 11 illustrates the method of this embodiment. First, the gamer inserts credits 130 in the electronic gaming device for further use to place bets 132. The gamers choose the amount of the bet 132 used to play the game. Then, the gamer presses the DEAL button 134, informing the electronic gaming device that all the previous steps to the game have been completed. At this time, two sets of three cards are dealt 136, one above the space dedicated to the Poker hand and one below. The gamer has all information required to make the best decision 138 regarding which cards to use to compose the initial Poker hand. They choose the best cards 138 based on their judgement. When all three cards are chosen, or when the gamer presses the DONE button, the remaining cards from the sets are removed and the Poker hand is ready to be completed 140. The step of holding or discarding cards 142 now takes place and final cards are dealt 144 to complete the poker hand. The cards composing the final Poker hand are evaluated 146. If the final Poker hand corresponds to a winning hand category, the gamer is awarded 148 a prize in regard to the category and the bet placed at the beginning of the play.

The final embodiment consists of the application of this method, and particularly the last above-mentioned method on an electronic Blackjack game. The method consists of offering a choice between two cards to the gamers. After the gamer has chosen one of the two cards, an additional card is dealt and the play continues. The gamer continues the play as usual. However, the gamer has the advantage of choosing the initial card. To equalize the chances for the electronic gaming device, other options are removed from the gamer's possibilities, such as the split feature.

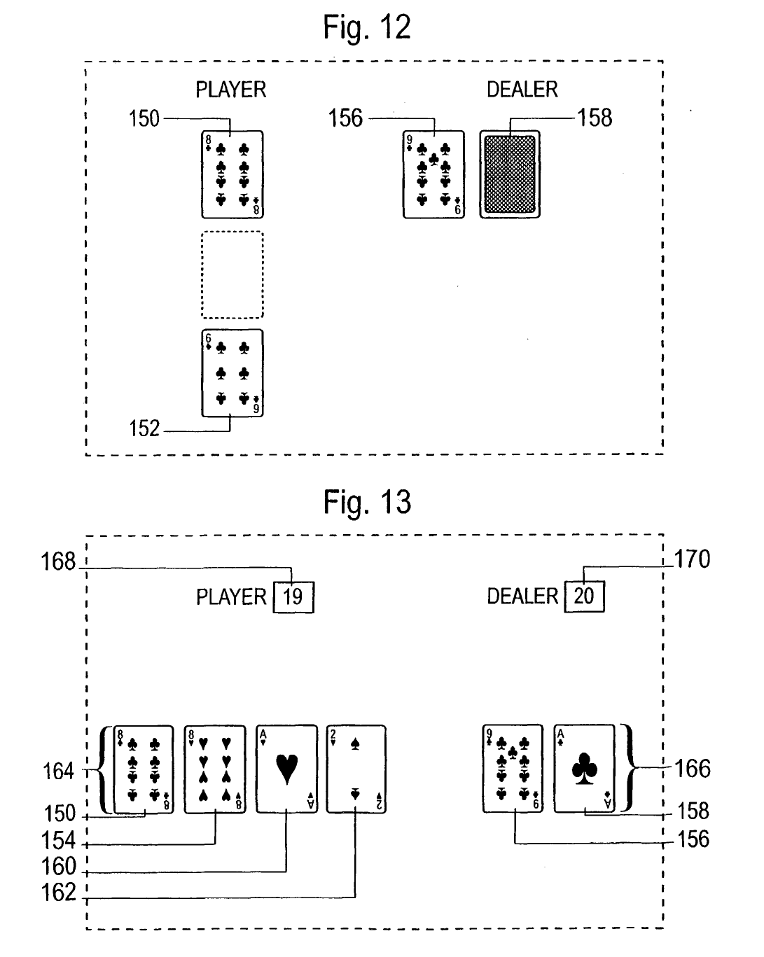

FIG. 12 illustrates a portion of the screen corresponding to the cards dealt to the gamer. As seen in FIG. 12, at this point in the play; the gamer is dealt two cards face up 150 and 152. At the same time, the dealer is dealt one card face up 156 and one card face down 158. At this moment, the gamer must choose which of the two cards 150 or 152 will be part of the play and which will be discarded.

FIG. 13 illustrates the same portion of the screen one step further into the play. At this time, the gamer has chosen a card to keep 150 and turned up a second card 154 to be part of the play. However, even if the card 154 has the same value as the first 150, the gamer cannot split the cards into two separate hands. This feature has been removed simultaneously to the addition of the feature associated with the present method. Next, a third 160 and a fourth 162 card has been dealt at the request of the gamer. And the card facing down 158 from the dealer has been turned up. The value of the sum of the cards of the gamer 164 and the dealer 166 are evaluated and displayed 168 and 170 to determine if the gamer is awarded a prize, and which prize is to be awarded.

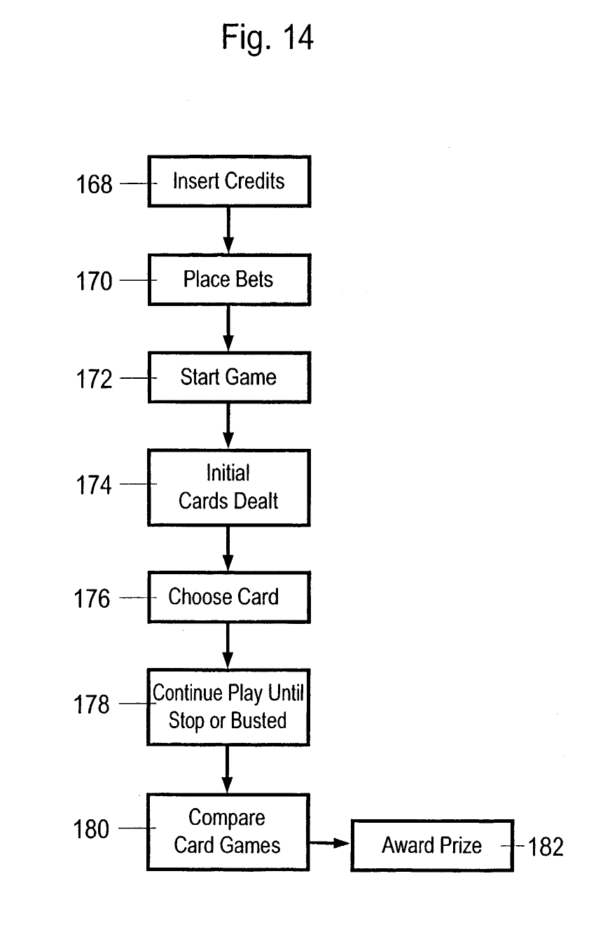

FIG. 14 illustrates the steps of playing using a flow chart. First, the gamer inserts credits 168 in the electronic gaming device for further use to place bets 170. The gamers then choose the amount of the bet 170 used to play the game. The gamer presses now the DEAL button 172, informing the electronic gaming device that all the previous steps to the game have been completed. At this time, the gamer receives two cards face up and the dealer one card face up and one card face down 174. The gamer then chooses whether to keep or discard one of the card to continue the play 176. He chooses the best cards based on his judgement. The play continues 178 as with a regular Blackjack game. The gamer sees their second draw card turned up. Followed by choosing to receive new cards or to stop with the actual cards. Afterwards, the dealer turns up his second card and complete the same steps according to predetermined rules. Finally, the card sum of the gamer and the card sum of the dealer are compared 180. Accordingly, the gamer is awarded a prize 182 in regards to the bet placed at the beginning of the play or not. If the gamer is awarded a prize, the prize increase the credits inserted earlier in the electronic gaming device.

FIG. 5 is a block diagram corresponding to playing a Blackjack game. First, a credit controller 60 manages the credit value inserted by the gamer. Then the game controller 64 allows the play to be played. Moreover, to play the play, the card controller 66 determines the cards being dealt. The game controller 64 allows the play to continue to the final outcome for the gamer and the dealer. When complete, the evaluation controller 68 evaluates the card sum of both the gamer and the dealer. The prize awarding system 70 awards the corresponding prize in regards to the information transmitted by the pay table controller 72. Simultaneously, during the progress of the game, the credit controller 60, the game controller 64, the evaluation controller 68 and the prize awarding system 70 continually transmits signals to the display controller 62 to keep accurate information available to the gamer.

1. An apparatus for playing a casino-type game, the apparatus comprising:
a display generator for displaying a plurality of sequences of equal number of gaming symbols in parallel with like members of said sequence being graphically displayed in a juxtaposed relation with respect to one another;
a user interface input device generating a user selection signal in response to user selection of any one of said members of said sequences; and
a final outcome sequence compiler receiving said user selection signal and outputting a final outcome data, wherein a player may select said members in any order to rapidly compile said final outcome.

2. The apparatus as claimed in claim 1, wherein said game is a card game, said symbols representing playing cards.

3. The apparatus as claimed in claim 2, wherein said plurality of sequences are two in number, said display generator providing a top row of cards for said first sequence, a bottom row of cards for said second sequence, and a middle row for said final outcome.

4. The apparatus as claimed in claim 3, wherein said user interface input device comprises a touch screen.

5. The apparatus as claimed in claim 4, wherein said final outcome compiler add new said gaming symbols to compile said final outcome.

6. The apparatus as claimed in claim 5, wherein said number of gaming symbols are at least three.

7. The apparatus as claimed in claim 5, wherein said final outcome compiler output said final outcome data when received a said user selection signal matching the number of said gaming symbols corresponding to the said final outcome.

8. A method of playing a casino-type game comprising:
selecting a plurality of sequences of equal number of gaming symbols;
displaying said gaming symbols in parallel with like members of said sequence being graphically displayed in a juxtaposed relation with respect to one another;
selecting, in any order, one of said members of said sequences;
compiling a final outcome sequence from a selection of one of each of said members; and
evaluating said final outcome sequence to determine a payout value.

9. The method as claimed in claim 8, further comprising a step of accepting a bet from a player to participate in said game, and paying said payout value to the player.

10. The method as claimed in claim 8 or 9, wherein said step of selecting comprises detecting user input identifying any one of said members and generating a selection signal.

11. The method as claimed in any one of claims 8 to 10, wherein step of compiling comprises to add said gaming symbols to yield said final outcome sequence with a number of said gaming symbols corresponding to a predetermined number of said gaming symbols.

12. The method as claimed in any one of claims 8 to 11, wherein the number of said sequences of equal number of gaming symbols is at least three.

13. The method as claimed in any one of claims 8 to 12, wherein said number of gaming symbols is at least three.

14. The method as claimed in any one of claims 8 to 13, wherein the number of said sequences of equal number of gaming symbols is at least one more than the number of said gaming symbol composing the said final outcome sequence.

15. The method as claimed in any one of claims 8 to 14, wherein said game is a Poker game.

16. A computer program comprising code means adapted to perform all steps of any one of claims 8 to 15, embodied on a computer readable medium.

17. A computer program comprising code means adapted to perform all steps of any one of claims 8 to 15, embodied on an electrical or electromagnetic signal.

18. A gaming device comprising:
a betting controller receiving information from a gamer, further said information being interpreted as bets
a game control generating signals representing outcomes in a game
a display controller displaying a representation of said signals on a gaming display
a prize awarding means to award prizes according to said outcomes and said bets; and
wherein said gaming device execute the steps defined in any one of claims 8 to 15.
